(19) United States
(12) Patent Application Publication
(10) Pub. No.: US 2010/0281387 A1
(43) Pub. Date: Nov. 4, 2010

(54) SYSTEMS AND METHODS FOR MANAGING BUILDING AUTOMATION SYSTEMS AND IT SYSTEMS

(75) Inventors: Scott T. Holland, Brookfield, WI (US); Jerald P. Martocci, Greenfield, WI (US); James B. French, Carmel, IN (US)

Correspondence Address: FOLEY & LARDNER LLP, 777 EAST WISCONSIN AVENUE, MILWAUKEE, WI, 53202-5306, US

(73) Assignee: Johnson Controls Technology Company

(21) Appl. No.: 12/770,150

(22) Filed: Apr. 29, 2010

Related U.S. Application Data
(60) Provisional application No. 61/174,949, filed on May 1, 2009.

(51) Int. Cl. G06F 15/16; G06F 15/177; G06F 3/048

(52) U.S. Cl. 715/735; 709/203; 715/853; 715/769; 709/201

(57) ABSTRACT

A system for managing building automation systems and information technology systems includes an IT management server in communication with a plurality of IT sites and a BAS integration server in communication with a plurality of BAS sites. The system further includes a user application server that communicates with the IT management server and the BAS integration server to provide at least one application for managing the plurality of IT sites and the plurality of BAS sites.

### CROSS REFERENCE TO RELATED PATENT APPLICATIONS

This application claims the benefit of U.S. Provisional Application No. 61/174,949, filed May1, 2009, which is incorporated by reference in its entirety.

### BACKGROUND

The present disclosure generally relates to building automation systems. A building automation system (BAS) is a hardware and/or software system configured to control, monitor, and manage equipment in or around a building or building area. BAS equipment can include a heating, ventilation, and air conditioning (HVAC) system, a security system, a lighting system, a fire alerting system, an elevator system, another system that is capable of managing building functions, or any combination thereof.

A conventional BAS typically relates to a single site (e.g., one building, one campus, etc.). A BAS site is not conventionally managed with an information technology (IT) site (e.g., a network or subnetwork established within a building or campus, a Windows domain, a building's internet protocol (IP) network, a data center, a distribution system, a delivery system, a structured cable system, an IDF closet, a client access system, a remote access system, an e-mail system, etc.). Rather, a BAS site is typically managed via a first server and a first set of user interfaces while the IT site is managed via a second server and a second set of user interfaces.

### SUMMARY

One embodiment of the invention relates to a system that includes an IT management server in communication with a plurality of IT sites and a BAS integration server in communication with a plurality of BAS sites. The system further includes a user application server that communicates with the IT management server and the BAS integration server to provide at least one application for managing the plurality of IT sites and the plurality of BAS sites.

Another embodiment of the invention relates to a user application server for managing a plurality of IT sites and a plurality of BAS sites. The user application server includes an enterprise service bus (ESB) interface. The user application server further includes a processing circuit that uses the enterprise service bus interface to communicate with an IT management server in communication with the plurality of IT sites and to communicate with a BAS integration server in communication with the plurality of BAS sites. The user application server may further include a memory device storing computer code for providing a graphical user interface (GUI) to an electronic display device or a remote client, the GUI for allowing a user to make configuration changes to the IT sites and the BAS sites. The GUI may include a navigation tree for browsing a hierarchy representing the plurality of IT sites and the plurality of BAS sites.

Another embodiment of the invention relates to a computer program product. The computer program product includes a physical computer readable medium having a computer readable program code stored therein, said computer readable program code for execution by a processor. The computer readable program code includes computer code for communicating with an IT management server in communication with a plurality of IT sites. The computer readable program code further includes computer code for communicating with a BAS integration server in communication with a plurality of BAS sites. The computer readable program code yet further includes computer code for managing the plurality of BAS sites and the plurality of IT sites via the IT management server and the BAS integration server. The computer readable program code may further include computer code for providing a graphical user interface (GUI) to an electronic display device or a remote client, the GUI for allowing a user make configuration changes to the IT sites and the BAS sites. The computer readable program code may yet further include computer code for generating a hierarchy of BAS sites and IT sites for display and user interaction via the GUI. The computer readable program code may also include computer code for communicating with the IT management server and the BAS integration server via an enterprise service bus.

Alternative exemplary embodiments relate to other features and combinations of features as may be generally recited in the claims.

### BRIEF DESCRIPTION OF THE FIGURES

The invention will become more fully understood from the following detailed description, taken in conjunction with the accompanying figures, wherein like reference numerals refer to like elements, in which:

FIG. 1 is a block diagram of a network server communicating with a plurality of sites, according to an exemplary embodiment;

FIG. 2 is a block diagram of the network server of FIG. 1 or a similar network server, according to an exemplary embodiment;

FIG. 3 is an illustration of a GUI for managing multiple BAS sites and multiple IT sites, according to an exemplary embodiment; and

FIG. 4 is block diagram of a system for managing multiple BAS sites and multiple IT sites, according to an exemplary embodiment.

### DETAILED DESCRIPTION

Before turning to the figures, which illustrate the exemplary embodiments in detail, it should be understood that the application is not limited to the details or methodology set forth in the description or illustrated in the figures. It should also be understood that the terminology is for the purpose of description only and should not be regarded as limiting.

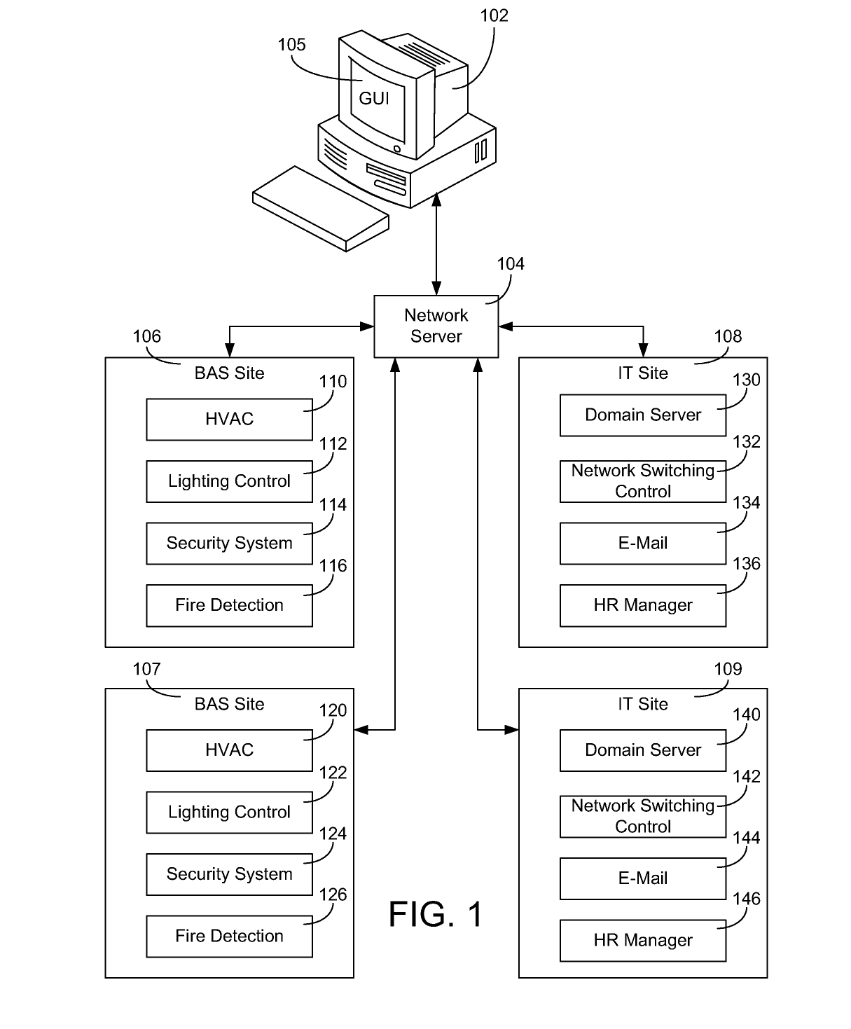

Referring to FIG. 1, a network server 104 is shown communicating with a plurality of BAS sites (BAS site 106 and BAS site 107) and a plurality of IT sites (IT site 108 and IT site 109). Network server 104 provides a graphical user interface (GUI) 105 for managing the plurality of BAS sites 106, 107 and the plurality of IT sites 108, 109. While BAS sites 106, 107 and IT sites 108, 109 are shown as separate for clarity, it should be noted that the BAS sites 106, 107 and the IT sites 108, 109 may be integrated and network server 104 may assist with such integration. For example, network server 104 may be used to associate BAS sites 106, 107 with certain IT site resources or to route BAS communications for a first BAS site through certain IT site resources. Further, in some embodiments of this application, the terms “network server” and “user application server” are used interchangeably.

GUI 105 can be provided to an electronic display device that is local to network server 104 or can be provided to a remote client such as workstation 102 configured to cause GUI 105 to be displayed when the GUI content is received from network server 104. GUI 105 may be provided to a client such as workstation 102 in the form of HTML documents, XML documents, streaming information, graphics, text, metadata, or other data. Via the GUI, network server 104 is configured to provide BAS management and information technology (IT) network management features for the plurality of different sites. Accordingly, via the single GUI a user may interact with and control multiple IT sites and multiple BAS sites. The system shown in FIG. 1 may advantageously provide a building manager or facilities manager with control of spatially diverse BAS and IT sites from a single location.

In FIG. 1 each BAS site 106, 107 includes a set of BAS subsystems such as HVAC systems 110, 120, lighting control systems 112, 122, security systems 114, 124, and fire detection systems 116, 126. BAS sites 106, 107 may include additional, fewer, or different BAS subsystems.

According to an exemplary embodiment, network server 104 is configured to control the plurality of BAS sites 106, 107 by controlling a plurality of BAS controllers, each BAS controller configured to control at least one BAS subsystem of each site. For example, a first BAS controller at BAS site 106 may provide local control to HVAC subsystem 110 and lighting control system 112 while a second BAS controller at BAS site 106 provides local control to security system 114 and fire detection system 116.

Each BAS may be or include METASYS building automation components sold by Johnson Controls, Inc. The BAS devices may be installed in any environment (e.g., an indoor area or an outdoor area) and may include any number of persons, buildings, spaces, zones, rooms, and any other object or area. The BAS controllers may be METASYS building automation system controllers. For example, the BAS controllers may be, or include features of, a METASYS Network Automation Engine (NAE) controller or another METASYS supervisory controller. Each BAS site, as discussed in the present disclosure, may be defined as having at least one BAS controller that is capable of autonomously managing the devices of a BAS.

An IT site, as used in the present disclosure, may refer to a collection of devices that comprise an IT network (e.g., a LAN) or IT network part (e.g., a subnetwork). An IT network may communicate according to an internet protocol (IP) or any other protocol for data communications. Each IT site 108 may include a controller or a plurality of controllers (e.g., a controlling switch, a traffic manager, an IT management server, etc.) configured to control the IT site. Alternatively, IT sites 108 may be managed in a distributed fashion (e.g., formed by the various IT devices that make up the IT site). In FIG. 1, each IT site is shown to include a set of IT subsystems including domain servers 130, 140, network switching control systems 132, 142, e-mail systems 134, 144, and HR management systems 136, 146. IT sites 108, 109 may include additional, fewer, or different IT subsystems. Domain server 130, network switching control 132, e-mail server 134, and HR management server 136 can be implemented in separate IT servers or in a single IT server for site 108. Network server 104 can be connected to the BAS sites 106, 107 and IT sites 108, 109 via direct connections, network connections, wireless connections, or any combination thereof.

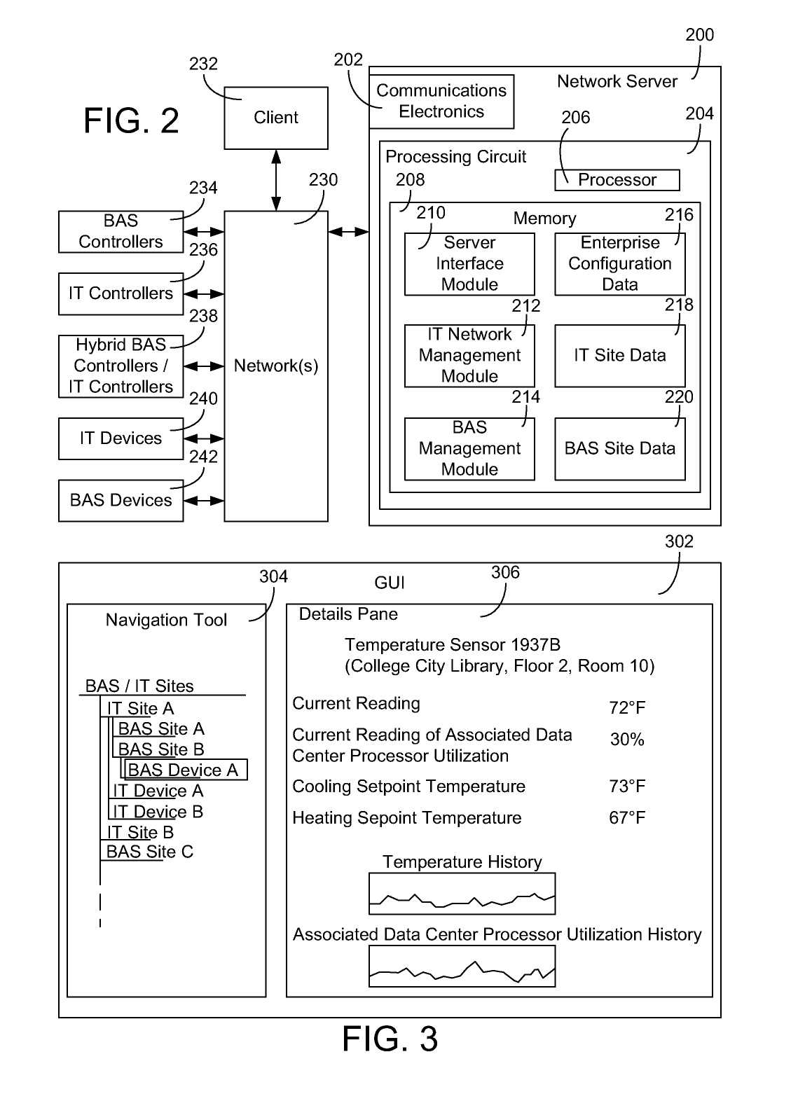

Referring now to FIG. 2, a block diagram of a network server 200 is shown, according to an exemplary embodiment. Network server 200 may be the same as or similar to the network server 104 shown in FIG. 1. Network server 200 includes communications electronics 202 connected to one or more networks 230 (e.g., the Internet, a local area network, a wide area network, an IP network, etc.). The one or more networks 230 are shown connected to BAS controllers 234, IT controllers 236, hybrid BAS controllers/IT controllers 238, IT devices 240 that form a distributed IT site, and BAS devices 242 that form a distributed BAS site. The one or more networks 230 are also shown to be connected to a client 232 configured to display the GUI on an electronic display device. In some embodiments client 232 may display the GUI on an electronic display local to network server 200.

According to some embodiments, client 232 may be a stand-alone or “thick” application configured to typically only receive some back-end data from network server 200 to provide the GUI. In yet other embodiments, client 232 can be implemented having varying other levels of GUI generation control (e.g., client 232 may display the GUI remote from network server 200). For example, client 232 may be a “thin” client configured to receive all content (e.g., graphics, layout, data, etc.) from network server 200 (e.g., as a web site).

Network server 200 is shown to include a processing circuit 204 including a processor 206 and memory 208. Processor 206 may be a general purpose processor, an application specific integrated circuit (ASIC), a circuit containing one or more processing components, a group of distributed processing components, or other hardware configured for processing. Memory 208 (e.g., memory unit, memory device, storage device, etc.) may be one or more devices for storing data and computer code for completing and/or facilitating the various processes described in the present disclosure when executed by processor 206. Memory 208 may include volatile memory and non-volatile memory. Memory 208 may include database components, object code components, script components, and any other type of information structure for supporting the various activities described in the present disclosure. Memory 208 is shown to include a server interface module 210, an IT network management module 212, a BAS management module 214, enterprise configuration data 216, IT site data 218, and BAS site data 220. Server interface module 210 may be a set of computer code or related data configured to control the activities of network server 200 relative to communications electronics 202, network 230, and client 232 and the GUI. For example, server interface module 210 may include one or more web servers or web services for receiving and responding to requests from client 232. IT network management module 212 may be or include computer code for communicating with the plurality of IT sites formed by IT devices 240 communicably coupled to network server 200. BAS management module 214 may be or include computer code for communicating with the plurality of BAS sites formed by BAS devices 242 communicably coupled to network server 200. Enterprise configuration data 216 may be one or more data stores or data structures configured to store information for the entire enterprise (e.g., setting data for the multiple sites, BAS sites to IT sites relationship data, GUI data, etc.). IT site data 218 may be or include one or more data stores or data structures configured to store information for the plurality of IT sites (e.g., addresses, settings, domain names, bandwidth limits, security breaches, security attacks, virus detections, server hits, processor usage, whether a server is online or offline, the number of clients logged into the IT site or resource, etc.) formed by IT devices 240. BAS site data 220 may be or include one or more data stores or data structures configured to store information for the plurality of BAS sites (e.g., energy usage information, setpoint information, control strategy information, policy information, etc.) formed by BAS devices 242.

Referring now to FIG. 3, a partial illustration of a GUI 302 for managing multiple BAS sites and multiple IT sites is shown, according to an exemplary embodiment. GUI 302 includes a navigation tool 304 in a pane on the left side of the GUI and a “details” pane 306 on the right side of GUI 302. Navigation tool 304 is configured to allow a user to browse and access a plurality of BAS sites and IT sites. Navigation tool 304 may be configurable such that a user may “build” a tree of sites that are of interest to him or her (e.g., by dragging and dropping site names in a tree-based hierarchy). According to other embodiments, the network server that provides GUI 300 content maintains data regarding physical and/or logical BAS site and IT site connections and uses the maintained data to populate navigation tool 304. The user may “click” on or otherwise select the name for each site in navigation tool 304. Upon user selection, GUI 300 may provide information regarding the selected site or sites to the user or provide the user with configuration options for the site or sites. In addition to configuration options, GUI 300 may provide the user with many different operational parameters or options for the site or sites (e.g., monitoring options or features, setpoint adjustment features, alarm and event management features, health monitor features, action options for responding to health monitor events, reconfiguration options, runtime control options, or other options available during operation of BAS sites or IT sites). Further, as mentioned above, the data for the BAS sites and the IT sites may be integrated, combined, or “mashed” up to create combined views or control GUIs that advantageously relate BAS site information with IT site information.

A details pane 306 (e.g., that shown on the right side of GUI 300), a pop-up box, or another GUI element may be configured to display information about a selected site or sites or to display the configuration options for the site or sites. Details pane 306 may be configured to allow a user to view and change configuration parameters for selected BAS sites, IT sites, BAS devices, and IT devices. As shown in details pane 306, the network server can advantageously relate or integrate BAS information (e.g., sensor temperature information) and IT site information (e.g., associated data center processor utilization). Such relationships can allow building managers to make more informed decisions (e.g., to adjust a setpoint in light of data center processor utilization trends).

Using navigation tool 304 or another set of user interface elements provided by GUI 302, the network server may provide the capability to allow a user to relate IT sites, BAS sites, and any devices or sub-sites of the system. For example, in a “drag and drop” navigation tool embodiment such as that shown in FIG. 3, GUI 300 may be configured to allow a user to drag “BAS Site A” and “BAS Site B” under “IT Site A.” Such an activity may cause “BAS Site A” and “BAS Site B” to be functionally related to “IT Site A.” This relation can mean that, for example, “BAS Site A” and “BAS Site B” are addressable under a common domain name, IP address block, or otherwise addressable based on parameters of “IT Site A.” Performance parameters (e.g., a quality of service (QoS) parameter), security parameters, routing parameters, and other network parameters can be inherited or utilized by “BAS Site A” and “BAS Site B” based on the relation. According to some exemplary embodiments, for example, when BAS sites are related to an IT site, the network server may calculate and provide parameters to each BAS site (e.g., controllers of the BAS Sites), may calculate and provide parameters to the IT site (e.g., to a controller, switch, or server for the IT site), or may otherwise control or affect an actual relation between the BAS sites and the IT site(s).

To the extent the BAS sites and the IT sites are functionally related (e.g., by two BAS sites utilizing one IT site's resources), GUI 300 can provide configuration tools for adjusting how the BAS sites and the IT site relate or interoperate. For example, QoS parameters of the IT site may be calculated and adjusted by the network server based on characteristics of the BAS sites (e.g., so that the BAS sites are optimally served by the IT site). The network server may be configured to communicate with the BAS sites and the IT sites to gather information that the network server can use to make configuration calculations and decisions. GUI 300 may also be configured to serve as a “system health” monitor for the multiple BAS sites and multiple IT sites. Accordingly, one or more graphs or other graphical indicia of system performance or health may be shown and updated regularly on GUI 300.

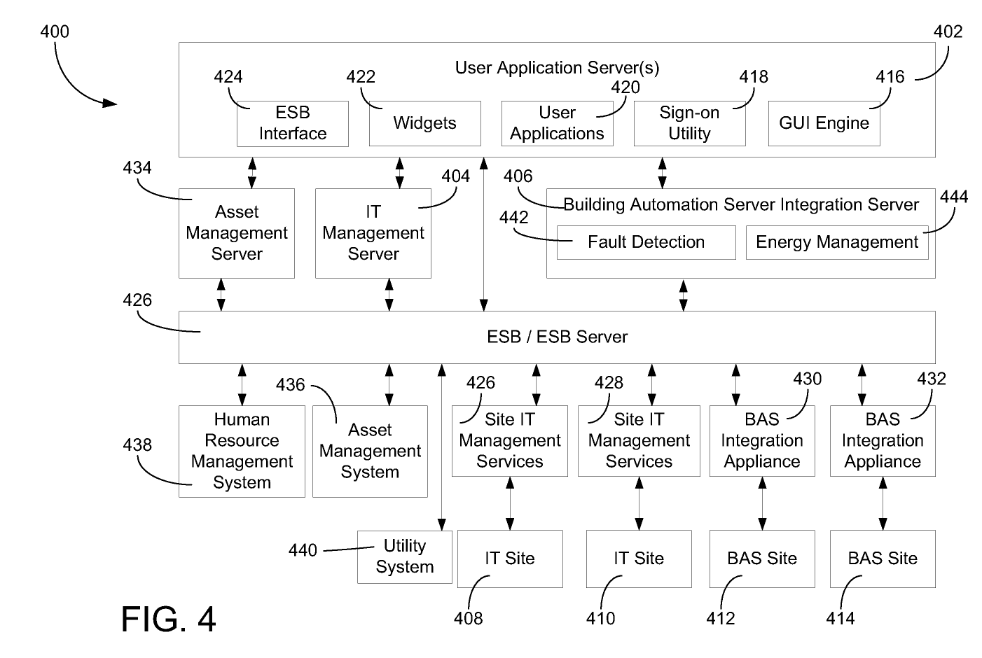

Referring now to FIG. 4, a block diagram of a multi-site BAS and IT management system 400 is shown, according to an exemplary embodiment. System 400 is shown to include a user application server 402. User application server 402 may be an alternative embodiment to the network server shown in previous Figures. User application server 402 may include processing electronics and a processing circuit as described above with respect to the network server shown in FIG. 2. User application server 402 is shown as connected to an IT management server 404 and a building automation integration server 406. IT management server 404 is in communication with a plurality of IT sites 408, 410. BAS integration server 406 is in communication with a plurality of BAS sites 412, 414. Each of the BAS sites 412, 414 may include at least one BAS controller (e.g., a METASYS NAE) that is capable of managing BAS devices and each of the IT sites 408, 410 can include at least one controller for controlling the IT site. User application server 402 can provide a plurality of applications for managing the IT sites and the BAS sites. For example, user application server 402 can include a GUI engine 416 for generating a graphical user interface such as that shown and described with respect to FIG. 3. User application server 402 is further shown to include a sign-on utility 418, user applications 420, widgets 422, and enterprise service bus (ESB) interface 424. Sign-on utility 418 can be configured to authenticate a client device or client user with the plurality of BAS sites, IT sites, or controllers thereof. User applications 420 can be, e.g., HVAC control applications for one or more sites, security control and monitoring for a plurality of sites, a digital vision network for monitoring a network of cameras, a lighting control system, an asset tracking system, a fire control system, an energy monitoring application, or other IT and/or BAS applications. Widgets 422 can be modular user interface elements that can be loaded by GUI engine 416 or used by user applications 420 to “mash-up” data from IT sites and BAS sites in specific ways. ESB interface 424 is configured to provide for protocolled communications with ESB 426. For example, ESB interface 424 may be configured to format or “wrap” IT messages or BAS messages for transmission on ESB 426 and interpret or “unwrap” IT messages or BAS messages from ESB 426.

While user application server 402 can communicate directly with site IT management services 426, 428, and BAS integration appliances 430, 432, user application server 402 may also or alternatively communicate with IT management services 426, 428 and BAS integration appliances 430, 432 via IT management server 404 and BAS integration server 406. IT management server 404 can be an enterprise level IT management or monitoring server configured to manage a plurality of downstream servers and services that make-up an IT site. For example, IT management server 404 can be an IBM Tivoli monitor and/or IBM OMNIbus operations management server. IT management server 404 may aggregate IT site information to provide automated event correlation, incident isolation, and resolution services. IT management server 404 can provide data consolidation and can collect business or technology events from many different IT site sources.

BAS integration server 406 is configured to collect BAS information (e.g., events, alarms, historical data points, setpoint information, configuration information, device name information, etc.) from the varying BAS sites 412, 414 via BAS integration appliances 430, 432. BAS integration server 406 can track BAS assets, conduct energy management calculations or tasks (e.g., using energy management module 444), conduct fault detection (e.g., using fault detection module 442), conduct event management, or conduct multi-site control. BAS integration server 406 can collect BAS data from disparately controlled BAS sites. For example, some of the BAS sites that BAS integration server 406 collects data from can be fully-open systems that communicate via open BAS protocols and communications technologies (e.g., OPC, SNMP, Modbus, Lonworks, BACnet, etc.) while other BAS sites that BAS integration server 406 collects data from can operate according to proprietary standards (e.g., LonWorks, N2, etc.). In an exemplary embodiment, BAS integration server 406 can be an EnNET Enterprise server or a Sustainability Manager server sold by Johnson Controls, Inc. and is configured to provide a centralized integration environment for a plurality of BAS sites. Each BAS Site 412, 414 is shown as locally coupled to a BAS integration appliance server 430, 432. BAS integration appliances 430, 432 can read, store, and forward information to ESB 426 and to BAS integration server 406 or user application server 402. BAS integration appliances 430, 432 can translate many different BAS device protocols (Modbus, N2, Sedona, BACnet, etc.) to a format compatible with ESB 426 (e.g., an XML format compatible with the ESB). In an exemplary embodiment, BAS integration appliances 430, 432 are Johnson Controls EnNET Site Servers.

Asset management server 434 can provide information to user application server 402 for providing asset management user interfaces to the a user GUI or widget. Asset management server 434 can be a Archibus server, an FM Works server, or otherwise. Asset management server 434 can communicate with one or more asset management systems 436 on the ESB. Sign-on utility 418 or other applications of user applications server 402 can utilize resources of human resource management system 438. For example, HVAC needs can be adjusted based on the number of human entities expected to populate a workspace. In another example, asset management server 434 can communicate with a security system to determine when entries to a building space are authorized.

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions. Software implementations could be accomplished with standard programming techniques with rule based logic and other logic to accomplish the various connection steps, processing steps, comparison steps and decision steps.

What is claimed is:

1. A system comprising:
an IT management server in communication with a plurality of IT sites;
a building automation system (BAS) integration server in communication with a plurality of BAS sites; and
a user application server that communicates with the IT management server and the BAS integration server to provide at least one application for managing the plurality of IT sites and the plurality of BAS sites.

2. The system of claim 1, wherein the user application server is configured to integrate the management of the plurality of IT sites and the plurality of BAS sites.

3. The system of claim 1, wherein each of the plurality of BAS sites includes at least one BAS controller that is capable of managing BAS devices; and wherein each of the plurality of IT sites includes at least one controller for controlling the IT site.

4. The system of claim 1, wherein the at least one application for managing the plurality of IT sites and the plurality of BAS sites is a graphical user interface (GUI) that allows a user to make at least one of configuration changes and operational changes to the IT sites and the BAS sites.

5. The system of claim 4, wherein the GUI comprises a navigation tree for browsing a hierarchy representing the plurality of IT sites and the plurality of BAS sites.

6. The system of claim 5, wherein the at least one application for managing the plurality of IT sites and the plurality of BAS sites allows the user to build the hierarchy.

7. The system of claim 6, wherein the application for managing the plurality of IT sites allows a user to build the hierarchy by accepting drag and drop inputs of site identifiers.

8. The system of claim 6, wherein the application for managing the plurality of IT sites maintains data of physical and logical BAS site and IT site connections and uses the maintained data to populate the hierarchy.

9. The system of claim 4, wherein the GUI comprises a details pane for displaying at least one of configuration parameters and operational parameters for selected BAS sites and IT sites.

10. The system of claim 4, wherein the GUI is configured to serve as a health monitor for the multiple BAS sites and the multiple IT sites.

11. The system of claim 1, wherein each of the IT management server, the BAS integration server, and the user application server comprise an enterprise service bus (ESB) interface and communicate with each other via an ESB protocol.

12. The system of claim 1, wherein the IT management server, the BAS integration server, and the user application server are integrated within the same network server and wherein the IT management server communicates with controllers at the plurality of IT sites.

13. The system of claim 1, wherein the IT management server is configured to store and access IT information for a plurality of IT devices existing within the plurality of IT sites.

14. A user application server for managing a plurality of IT sites and a plurality of building automation system (BAS) sites, the user application server comprising:
an enterprise service bus (ESB) interface; and
a processing circuit that uses the ESB interface to communicate with an IT management server in communication with the plurality of IT sites and to communicate with a BAS integration server in communication with the plurality of BAS sites.

15. The user application server of claim 14, further comprising:
a memory device storing computer code for providing a graphical user interface (GUI) to an electronic display device or a remote client, the GUI for allowing a user to make configuration changes to the IT sites and the BAS sites.

16. The user application server of claim 15, wherein the GUI comprises a navigation tree for browsing a hierarchy representing the plurality of IT sites and the plurality of BAS sites.

17. A computer program product, comprising:
a physical computer readable medium having a computer readable program code stored therein, said computer readable program code for execution by a processor and comprising:
computer code for communicating with an IT management server in communication with a plurality of IT sites;
computer code for communicating with a BAS integration server in communication with a plurality of BAS sites; and
computer code for managing the plurality of BAS sites and the plurality of IT sites via the IT management server and the BAS integration server.

18. The computer program product of claim 17, further comprising:
computer code for providing a graphical user interface (GUI) to an electronic display device or a remote client, the GUI for allowing a user to make at least one of configuration changes and operational changes to the IT sites and the BAS sites.

19. The computer program product of claim 18, further comprising:
computer code for generating a hierarchy of BAS sites and IT sites for display and user interaction via the GUI.

20. The computer program product of claim 19, further comprising:
computer code for communicating with the IT management server and the BAS integration server via an enterprise service bus.
